(19) United States
(12) Patent Application Publication
(10) Pub. No.: US 2024/0201373 A1
(43) Pub. Date: Jun. 20, 2024

(54) MEASUREMENT SYSTEM WITH AUTOMATIC TRACKING FOR CUSTOMIZING SWIMMING POOL COMPONENTS

(71) Applicant: Latham Pool Products, Inc., Latham, NY (US)

(72) Inventor: Will Cappiello, Latham, NY (US)

(21) Appl. No.: 18/537,348

(22) Filed: Dec. 12, 2023

Related U.S. Application Data
(60) Provisional application No. 63/433,697, filed on Dec. 19, 2022.

(51) Int. Cl. G01S 17/08; G01S 7/497; G01S 17/894; G06K 7/14; G06T 7/20; G06T 17/00; H04N 23/61

(52) U.S. Cl. CPC G01S 17/08; G01S 7/4972; G01S 17/894; G06K 7/1404; G06T 7/20; G06T 17/00; H04N 23/61

(57) ABSTRACT

Some examples of the present disclosure relate to a measurement system with automatic tracking for measuring the perimeter of a swimming pool. In one example, a measurement system can track movement of a target object around a perimeter of a swimming pool by analyzing images of the target object received from a camera. While tracking the movement of the target object, the measurement system can automatically control an orientation of a ranging device to follow the movement of the target object. The measurement system can receive a user request to acquire range data. In response to the user request, the measurement system can instruct the ranging device to collect the range data while the ranging device is oriented toward the particular location. The measurement system can then receive the range data and store the range data to a storage device.

### CROSS-REFERENCE TO RELATED APPLICATION

This application claims priority to U.S. Provisional Application No. 63/433,697, titled “MEASUREMENT SYSTEM WITH AUTOMATIC TRACKING FOR CUSTOMIZING SWIMMING POOL COMPONENTS” and filed on Dec. 19, 2022, the entirety of which is hereby incorporated by reference herein.

### TECHNICAL FIELD

The present disclosure relates generally to customizing components of swimming pools. More specifically, but not by way of limitation, this disclosure relates to an automated measuring system for customizing components for a swimming pool.

### BACKGROUND

Customers often purchase components for their swimming pools, including safety covers and liners. These components work best when they are customized to fit the size and shape of a swimming pool. Many swimming pools will also have anchors installed for mounting components like covers. To obtain the best fit, a pool component manufacturer will often send a technician to the customer's property to manually measure various aspects of the customer's swimming pool, such as its perimeter, shape, anchor locations, and locations of fixtures. But manual measurements can be expensive, time consuming, and inaccurate.

### BRIEF DESCRIPTION OF THE DRAWINGS

FIGS. 1-3 depict schematic diagrams of an example of an automated measurement system for customizing swimming pool components, according to some aspects of the present disclosure.

FIG. 4 is a block diagram of an example of a measurement system usable to implement some aspects of the present disclosure.

FIG. 5 is a flow chart of an example process for locating a target positioned adjacent to a swimming pool and determining range data for the target, according to some aspects of the present disclosure.

### DETAILED DESCRIPTION

Certain aspects and features of the present disclosure relate to a measurement system with automatic tracking for use in measuring the perimeter of a swimming pool to customize swimming pool components. In some examples, the measurement system can include a camera that can capture images of a target moving around the perimeter of the swimming pool. The target may be any physical object that can be held by a technician as the technician walks around the perimeter of the swimming pool. The measurement system can process the images to automatically track the location of the target as the target moves around the perimeter of the swimming pool. While performing this tracking, the measurement system can also automatically control the orientation of a ranging device (e.g., a laser scanner) based on the position of the target around a swimming pool. When the target is at a particular location around the perimeter of the swimming pool, the measurement system can trigger the ranging device to generate a range measurement indicating the distance from the ranging device to the designated location. The particular location may, for example, correspond to an anchor location at which an anchor is to be installed for attaching a safety cover or other pool component. The measurement system can then use the range measurement to accurately determine the position of the target, as well as to determine distances or other dimensions corresponding to the swimming pool. For example, the measurement system can determine the perimeter of the swimming pool, including curved and irregularly shaped pools and pools with decks of varying height around the perimeter of the pool. The measurement system can also compute dimensions for pool components such as safety covers and liners.

Recent improvements to conventional, manual measurement techniques include using image analysis to facilitate computing dimensions of a swimming pool. Such systems may use a camera to take multiple images of a swimming pool and the surrounding site to determine the perimeter and shape of the pool. While this can be faster than traditional manual measuring, it still has several problems. For example, the accuracy of this approach can depend on the quality and calibration of the cameras, their relative proximity to one another, the number of cameras, lighting conditions, and other factors. Additionally, some features of a swimming pool may be difficult to accurately capture in an image. For example, anchors for a pool cover may be installed flush with the deck, so they may be relatively imperceptible in images of the swimming pool. This can make it challenging for image-based measurements systems to identify the locations of the anchors, which in turn can reduce the accuracy of those systems and their ability to accurately model a custom pool cover. As another example, changes in the height or slope of the pool deck can obscure the camera's view, which can prevent the camera from capturing important features.

Some examples of the present disclosure can overcome one or more of the abovementioned problems by using a ranging device to improve the accuracy of measurements and by using object tracking to allow for quick and easy identification of features (e.g., anchors) that may otherwise be obscured from the camera's view. For instance, the measurement system can automatically process images from a camera to track a target as the target is moved and positioned at locations around the swimming pool, including locations of features that may be flush with the surface of the pool or otherwise imperceptible from the camera's view. While tracking the target, the measurement system can automatically control the orientation of the ranging device to follow the target. When the target is in a desired location, such as an anchor location, the technician may trigger the ranging device to take a distance measurement. The technician can then move to the next location and repeat this process. The automatic tracking can allow a single technician to reposition the target at various locations around the pool and capture measurements in a fast and efficient way, greatly speeding up the measurement process.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

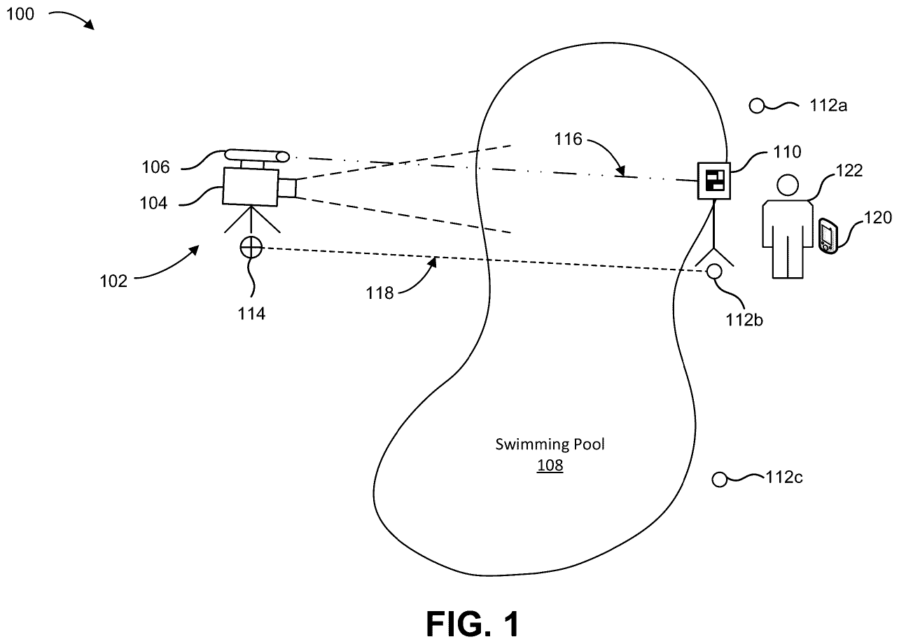

FIGS. 1-3 are schematic views of an example measurement system 100 with automatic tracking for swimming pool components, according to some aspects of the present disclosure. The measurement system 100 includes a scanning subsystem 102. The scanning subsystem 102 can include a camera 104 for capturing images of a target 110 positioned near a swimming pool 108. The scanning subsystem 102 can also include a ranging device 106 that is separate from the camera 104 and usable for measuring distances to locations around the swimming pool 108. The scanning subsystem 102 can include a computer to control the operation of the camera 104 and the ranging device 106. The scanning subsystem 102 can also include actuators or other similar drive mechanisms to rotate, move, or otherwise orient the camera 104 and/or the ranging device 106 to track the target 110. For example, the scanning subsystem 102 can include a tripod with a motorized mount for the camera 104 and/or ranging device 106 that can rotate them about one or more axes while the scanning subsystem 102 remains in one location. As the target 110 moves to various locations adjacent to the swimming pool 108, the measurement system 100 can automatically track the target 110 and obtain distance measurements between the target 110 and the ranging device 106.

More specifically, the camera 104 can capture images of the target 110 as the target 110 moves around the perimeter of the swimming pool 108. The camera 104 may include a video camera, a single camera, multiple cameras, or another camera arrangement configured to capture images at a particular cadence, for example 30 images per second. The measurement system 100 can use the images of the target to track the location of the target 110. For example, the measurement system 100 can, using images from the camera 104, rotate the camera 104 to center the target 110 within the view of the camera 104. If the target 110 moves, the measurement system 100 can rotate the camera to keep the target 110 in the field of view of the camera 104. The measurement system 100 can perform this tracking in real time or near-real time with the motion of the target 110, so that the camera 104 follows the target 110 in its movements.

In some examples, the measurement system 100 can control the orientation of the ranging device 106 based on the tracking performed using the camera 106. For example, the camera 104 and the ranging device 106 can be attached to the same actuator, so that when the camera 104 is rotated, the ranging device 106 is also rotated at the same time. This can keep the ranging device 106 in alignment with the camera 104. As another example, the camera 104 and the ranging device 106 can be attached to different actuators. The camera tracking can be used to control the ranging device's actuator to keep the ranging device 106 pointed at the target 110. These techniques can allow the ranging device 106 to follow the target 110 as it moves, so that the ranging device 106 can be used to obtain ranging information almost as soon as the target 110 reaches a desired location around the swimming pool 108.

In some examples, the ranging device 106 can include a laser rangefinder, an optical time-of-flight sensor using a light emitting diode or other light source, a depth camera, or any combination of these. In other examples, the ranging device 106 need not be an optical device and can use radio (e.g., radar), sound (e.g., ultrasonic ranging), or other techniques to measure distance. The ranging device 106 can be a separate instrument from the camera 104 that is mounted in a fixed alignment with the camera 104. The fixed alignment can ensure that the fields of capture (e.g., optical axes) of both the ranging device 106 and the camera 104 are parallel, so that both devices point in the same direction when the scanning subsystem 102 is oriented to view the target 110. Mounting the ranging device 106 in a fixed alignment with the camera 104 can also provide a known offset between the ranging device 106 and the camera 104, which can be used by the measurement system 100 when computing distances to the target 110.

The ranging device 106 can be configured to obtain range measurements or other range data corresponding to a distance from the ranging device to the target 110. For a laser rangefinder, obtaining the range data can include transmitting a laser pulse along the path 116 to strike the target 110 and capturing a reflection of the laser pulse. The range data can then be used by the measurement system 100 to determine a distance 118 between the location of the scanning subsystem 102 (e.g., reference location 114) and the location of the target 110. The measurement system 100 can also use the range data to determine other dimensions associated with the swimming pool 108. For example, the measurement system 100 can determine the height of the location of the target 110 relative to the reference location 114 and relative to other target locations for which range data has been obtained.

The target 110 can be any suitable object that is identifiable by the scanning subsystem 102 using image-analysis techniques. For example, the target 110 can be a flat polygonal sign at the top of a pole or stand. The polygonal shape of the sign can provide well-defined edges that can aid in image analysis and tracking using the camera 104. The polygonal sign can be rectangular, triangular, or other shape. In some examples, the target 110 can include markings (e.g., such as text, symbols, or shapes) to improve the visibility or readability of the target 110 by the camera 104 and/or provide additional information about the target 110 to the scanning subsystem 102. The markings can include a fiducial having black and white or other contrastingly colored shapes of known dimensions that can be imaged with the camera 104. The markings can additionally or alternatively include a machine-readable optical code, a reticle, or other reference markings. The markings could indicate the dimensions of the target 110 or other information about the target 110. For example, a machine-readable optical code could include information about a known height of the pole onto which the sign is attached and/or the dimensions (e.g., length and width, area) of the sign. The optical code could be readable by the scanning subsystem 102 to determine the dimensions of the target 110 for use in subsequent calculations.

In the example depicted in FIGS. 1-3, the target 110 can be attached to a stand and physically positioned around the perimeter of the swimming pool 108 by a user 122. As the user 122 carries the target 110 to different locations, the scanning subsystem 102 can track the target 110 and obtain range data for the target 110 using the ranging device 106. In some examples, the target 110 need not be a sign or other purpose made object. The target 110 could even be the user 122 standing adjacent to the swimming pool 108 and walking from location to location. The scanning subsystem 102 could then track the user 122 using images from the camera 104 and obtain range measurements for a distance to the user 122. In other examples, the target 110 could also be (or could be mounted on) an autonomous or semi-autonomous robot that can move around the swimming pool 108 and locate anchors or other positions while being tracked using the scanning subsystem 102. The robot could be a wheeled robot or an aerial drone with its own camera system for navigation independent of the camera 104 and scanning subsystem 102. The robot could be in communication with the scanning subsystem 102 to coordinate positioning of the target 110 and obtaining range data.

Range data can be obtained with respect to one or more target locations around the swimming pool 108. For example, FIGS. 1-3 depict target locations 112a, 112b, and 112c, but more or fewer target locations may be present at a swimming pool site. The target locations 112a-c can be adjacent to the swimming pool 108. As used herein, “adjacent” can include positions where the target locations are at the edge of the swimming pool 108 as well as positions where the target locations are spaced apart from the edge of the swimming pool 108. For example, the target locations 112a-c can correspond to the positions of anchor points that are installed flush with the surface of the pool deck and a few feet from the edge.

The scanning subsystem 102 can be positioned at the reference location 114, which may be an arbitrary location near the swimming pool 108 that is selected for its suitability for staging the measurement system 100 and viewing the target 110 at the target locations 112a-c around the swimming pool 108. For example, the reference location 114 can be a level portion of the swimming pool deck that allows the camera 104 to have a clear view of each target location 112a-c. The scanning subsystem 102 may the undergo a calibration process to facilitate object tracking and range sensing.

After the scanning subsystem 102 is set up (e.g., positioned and calibrated), the user 122 can position the target 110 at various locations around the swimming pool 108. For example, the user 122 can walk around the perimeter of the swimming pool to location 112b while holding the target 110. The camera 104 can obtain images of the target 110 as the user 122 moves to location 112b. Based on the images, the scanning subsystem 102 can perform object tracking to orient the camera 104 to follow the target 110, as well as align the ranging device 106 with the target 110. Object tracking can include identifying one or more objects within the images, including the target 110 and the user 122, recognizing those objects in different positions in different image frames, and determining the extent to which the identified objects have moved within the images. Object tracking in computer vision systems can include one or more algorithms that can function to detect objects in the images, classify the objects, and determine motion of the detected objects. Example algorithms for object detection include convolutional neural network algorithms (e.g., YOLO, OpenCV) that can be trained using machine learning techniques to identify and classify objects in an image. For example, the user 122 could be detected based upon a tracker trained to identify faces of people, while the target 110 could be detected based upon a tracker trained to identify signs containing target markings. The object tracking algorithm can then determine the position of the target 110 in the images and control the scanning subsystem 102 to move the camera 104, for example so that the detected target 110 in subsequent image frames is closer to the center of the image.

Once the target 110 is positioned at location 112b, the ranging device 106 can obtain range data for the target 110 that can be used to determine the distance 118. The user 122 can then move the target to another location, for example target location 112a. The measurement system 100 can track this movement, orient the ranging device 106, and obtain range data for the next location. The user 122 can move the target 110 to additional locations around the swimming pool 108, such as location 112c, until sufficient range data is captured for the target locations.

In some examples, the user 122 can operate a user device 120 to aid in capturing the range data and/or positioning the target 110. The user device 120 can be a smart phone, tablet, laptop, wearable device (e.g., a smart watch), or other computing device. The user device 120 may communicate with the scanning subsystem 102 to transmit and receive instructions, range data, images, or other information. For example, the user device 120 may execute an application that includes a graphical user interface. The graphical user interface may show images captured by the camera 104 in real time, range data generated by the ranging device 106, and the like. And in some examples, the graphical user interface can include a button for controlling the ranging device 106. For instance, once the target 110 is in position, the user 122 can press the button to trigger the acquisition of range data by the ranging device 106, where the range data can indicate a distance to the target 110. For example, the user device 120 can detect the button press and responsively transmit an indication to the scanning subsystem 102, which can respond to the indication by generating range data using the ranging device 106. In this way, the user 122 can control when the ranging device 106 generates the range data to prevent premature or inaccurate measurements. In some examples, the measurement system 100 can determine, based on images from the camera 104, that the target 110 is stationary and centered within the view of the camera 104. Based on this determination, the measurement system 100 can cause the user device 120 to present an indication to the user 122 that the target is stationary and in view. In some examples, the user device 120 can also provide instructions to the user 122 to position the target 110 at or near a particular location. For example, the scanning subsystem 102 can determine that previously generated range data for a location was inaccurate or incorrect and transmit instructions to the user device 120 to have the user 122 reposition the target 110 at the location for which the incorrect range data was generated.

In some examples, the scanning subsystem 102 can generate and/or store a model of the swimming pool 108. The model can be a three dimensional (3D) model that is generated using range measurements from the ranging device 106, images from the camera 104, and/or images from other cameras. In some examples, photogrammetry techniques may be used to construct the 3D model. The 3D model can be displayed at the user device 120. Representations of the target locations 112a-c can be included within the 3D model to help the user 122 visualize those locations. As discussed above, imaging-based models may not be able to accurately resolve all features of the swimming pool 108 and its environment like anchors that are flush with the pool deck. The scanning subsystem 102 can determine if a feature of the pool site should have additional range measurements captured. The scanning subsystem 102 can then generate instructions identifying a location of the desired feature and directing the user 122 to position the target 110 at the location. The scanning subsystem 102 can also determine that the accuracy of dimensions of the 3D model can be improved with additional range data at additional locations around the swimming pool 108 and generate instructions directing the user 122 to position the target 110 at those additional locations. In this way, the scanning subsystem 102 can provide guidance to the user 122 about how to improve the model of the swimming pool 108.

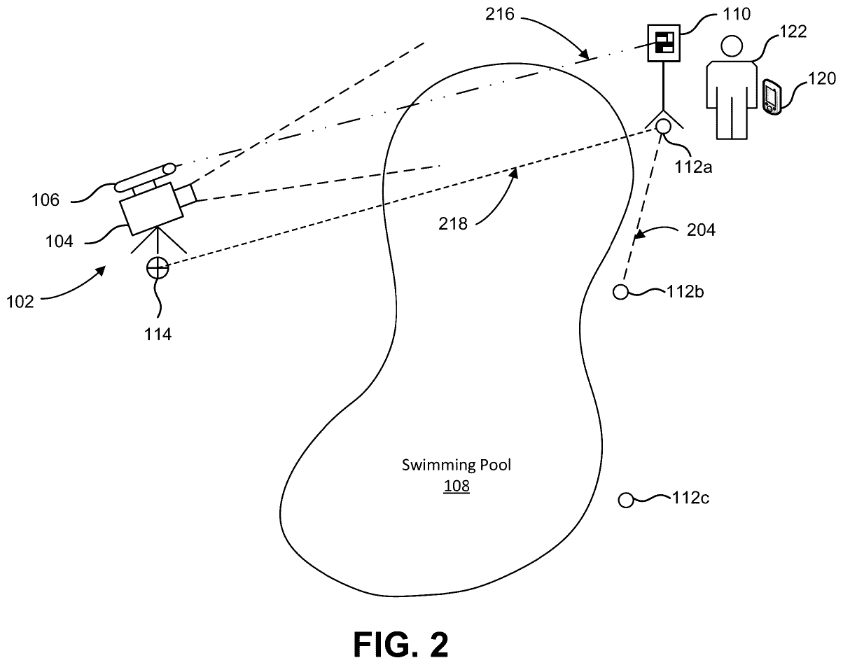

Continuing the example from above, the measurement system 100 can capture range data related to location 112b, after which the user 122 can move the target 110 to location 112a. An example of this is shown in FIG. 2. While the target 110 is being moved, the scanning subsystem 102 can orient the ranging device 106 based on images captured by the camera 104, so that the path 216 is aligned with the target 110. The user 122 can press a button on the user device 120 indicating that the target is positioned at location 112a, in response to which the scanning subsystem 102 can obtain additional range data for the target 110 at location 112a. The measurement system 100 can then use the additional range data to determine a distance 218 between the reference location 114 and location 112a. Because the scanning subsystem 102 now has determined distance 118 and distance 218, the scanning subsystem 102 can then use the range data and distances to determine a segment distance 204 between location 112a and location 112b. The segment distance 204 can be the straight line distance between location 112a and location 112b. In some examples, the segment distance 204 can be the distance of an arc between location 112a and 112b that is parallel to the perimeter of swimming pool 108.

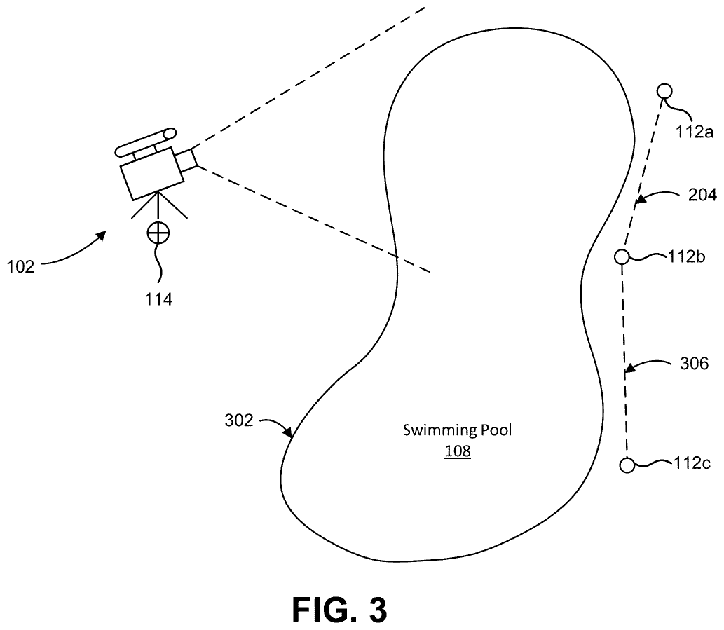

The above process can be repeated for location 112c, as shown in FIG. 3, to generate corresponding range data using the ranging device 106. The measurement system 100 can then determine segment dimension 306. The target 110 can also be positioned at additional locations around the perimeter of the swimming pool 108. The scanning subsystem 102 can add the segment dimensions to obtain a measurement of the perimeter of the swimming pool. The scanning subsystem 102 can also determine other dimensions associated with the swimming pool 108. For example, the measurement system 100 can determine the shape 302 of the pool (e.g., rectangular, circular, kidney shaped, irregular shapes, etc.); the shape of a pool component like a liner or cover; the total area for the pool or a pool component, including an extension of the component beyond the edge of pool; and the like. In examples where the target locations 112a-c correspond to anchor points for a pool cover, the measurement system 100 can determine the length of anchor straps or other attachments for a pool cover based on the segment distances and range data for the target locations 112a-c.

Although the description above depicts the scanning subsystem 102 as including both the camera 104 and the ranging device 106 at the same fixed location, in alternative arrangements the camera 104 and ranging device 106 can be positioned at different locations from one another. For example, the camera 104 may be positioned at an elevated location to give a better view of the target as it moves around the swimming pool, while the ranging device 106 is positioned at the reference location to provide improved sensing for collecting the range data. Additionally, it will be appreciated that some or all of the functionality described above as being performed by the “measurement system” can be implemented by the scanning subsystem 102, the user device 120, a server (e.g., located offsite), or any combination thereof.

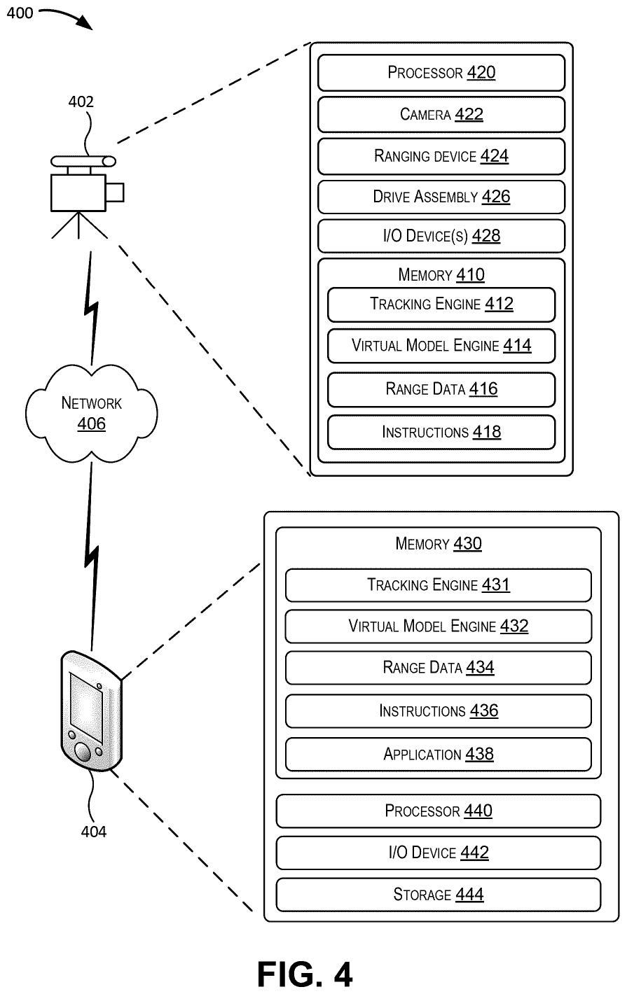

FIG. 4 is a block diagram of an example of a measurement system 400 according to some aspects of the present disclosure. The measuring system 400 may be an example of measuring system 100 of FIG. 1. The measurement system 400 can include scanning subsystem 402 and user device 404, which may be examples of scanning subsystem 102 and user device 120, respectively. The scanning subsystem 402 can communicate with the user device 404 over a network 406. The network 406 can be a cellular network, a Wi-Fi network, a Bluetooth network, or other network for communicating between computing device. In some examples, the network 406 may include the internet.

The scanning subsystem 402 can include a processor 420, a camera 422, a ranging device 424, a drive assembly 426, and one or more input/output (I/O) device(s) 428. The processor 420 can include one processor or multiple processors. Non-limiting examples of the processor 420 include a Field-Programmable Gate Array (FPGA), an application-specific integrated circuit (ASIC), or a microprocessor. The processor 420 can execute program instructions stored in the memory 410 to perform operations. In some examples, the program instructions can include processor-specific instructions generated by a compiler or an interpreter from code written in any suitable computer-programming language, such as C, C++, C #, and Java.

The camera 422 may be an example of camera 104 of FIGS. 1-3, while the ranging device 424 may be an example of ranging device 106 of FIGS. 1-3. The drive assembly 426 can include one or more actuators, including rotational actuators, linear actuators, and/or other actuators that can rotate, translate, or otherwise orient the measuring device. For example, the drive assembly 426 can be configured to rotate the measuring device about one or more axes to point the camera 422 and/or ranging device 424 in a direction based on analysis of images captured by the camera 422.

The I/O device(s) 428 can include displays, touch screens or touch panels, keyboards, number pads or control pads, or other similar I/O device. The I/O device(s) 428 can also include sensors for determining a current attitude or orientation of the scanning subsystem 402, for example an accelerometer, inclinometer, gyroscope, or the like, which can be used to calibrate the scanning subsystem 402 or for other purposes.

The memory 410 can include one memory device or multiple memory devices. The memory 410 can be non-volatile and may include any type of memory device that retains stored information when powered off. Non-limiting examples of the memory 410 include electrically erasable and programmable read-only memory (EEPROM), flash memory, or any other type of non-volatile memory. At least some of the memory 410 includes a non-transitory computer-readable medium from which the processor 420 can read program instructions. A computer-readable medium can include electronic, optical, and magnetic storage devices capable of providing the processor 420 with the program instructions or other program code. Non-limiting examples of a non-transitory computer-readable medium include magnetic disks, memory chips, ROM, random-access memory (RAM), an ASIC, a configured processor, and optical storage.

The memory 410 can include one or more application programs, services, or other components for implementing aspects of the present disclosure. For example, the memory 410 can include a tracking engine 412, a virtual model engine 414, range data 416, and instructions 418. The tracking engine 412 may be configured to capture images using the camera 422 and analyze the images to identify a target as the target moves in an environment. Based on the analysis, the tracking engine 412 can cause the drive assembly 426 to orient the scanning subsystem 402 to align the ranging device 424 with the target. Thus, the tracking can be at least partially performed by the scanning subsystem 402 in some examples. The virtual model engine 414 may be configured to generate or retrieve a 3D model of the swimming pool and the swimming pool environment. The virtual model engine 414 may also be configured to control the ranging device 424 to generate range data 416, for example by acquiring a range measurement corresponding to a location adjacent to the swimming pool. The virtual model engine 414 can then use the range data 416 to compute one or more dimensions corresponding to the swimming pool, including segment distances between target locations, a perimeter measurement of the swimming pool, distances of the target locations from the edge of the swimming pool, and the like. The virtual model engine 414 can update the 3D model based on the range data 416 and measurements computed based on the range data 416. For example, as range data 416 is acquired for each target location, the virtual model engine 414 can include an indication of the target location in the model.

The instructions 418 can include also include guidance generated by the virtual model engine 414 to position the target at a location. For example, to get an improved measurement for the 3D model, the virtual model engine 414 can determine a location near the swimming pool for which a range measurement would improve the accuracy of the 3D model. The virtual model engine 414 can generate guidance indicating the location in the environment and directing a user to position the target at the location. The instructions 418 may also be usable to move an automated system like a robot or drone to an additional location. In these examples, the robot may be configured to detect anchor points and move according to the instructions 418 to position the target at the locations.

Now referring to the user device 404, the user device 404 can include a processor 440, I/O device 442, storage 444, and memory 430. The processor 440 can include one processor or multiple processors, which may be similar to processor 420. The processor 440 can execute program instructions stored in the memory 430 to perform operations. The memory 430 may be similar to memory 410. The I/O device 442 can be similar to I/O device 428 and include a display, touch screen, or the like. The storage 444 may non-volatile memory configured to store software, program instructions, application data, and similar data. For example, storage 444 may be used to store the 3D model of the environment for presentation at the I/O device 442 as part of an augmented reality (AR) display.

The memory 430 of the user device 404 can include one or more application programs, services, or components for implementing aspects of the present disclosure. For example, the memory 420 can include a tracking engine 431, virtual model engine 432, range data 434, and instructions 436. The tracking engine 431 may be similar to tracking engine 412. The tracking engine 431 may be configured to receive images captured by the camera 422 and transmitted to the user device 404. The virtual model engine 432 may be similar to virtual model engine 414. In some examples, some, any, all, or combinations of the operations described herein for tracking engine 412 and virtual model engine 414 may be performed by tracking engine 431 and virtual model engine 414, respectively, for example by receiving range data 434 transmitted from the scanning subsystem 402. The instructions 436 may be similar to instructions 418 and may be generated by virtual model engine 414 and/or virtual model engine 432.

The application 438 may be executable by the processor 440 for causing the processor 440 to perform any of the functionality described herein. The application 438 may also be executable by the processor 440 to perform more functionality, less functionality, or different functionality than described herein. In some examples, the application 438 can be downloaded from an app store. In some examples, the application 438 can include tracking engine 431 and/or virtual model engine 432 as subcomponents of the application.

As one particular example of the functionality of the application 438, the application may cause a graphical representation of the 3D model to be presented at a display of the user device 404. The 3D model can be a model of the pool being measured and can include graphical representations of the target locations. The application 438 can also display various indications at the display. For example, the application 438 can display an indication, based on information transmitted from the measuring device, that the measuring device has been oriented toward the target. As another example, the application 438 can display error indications if the target is not being held stationary, if the target is no longer visible by the camera 422, or if range data for a target location has been determined to be inaccurate or invalid. In some examples, the application 438 may be configured to connect to a computer system of a swimming-pool component supplier to retrieve component information, including available components and component sizes/dimensions, based on the range data and/or other measurements computed by the measuring system 400.

Although FIG. 4 depicts the components (e.g., processor 420, camera 422 etc.) of each device as part of a single housing, in other examples the components may be distributed and in wired or wireless communication with one another. For example, the display of I/O device 442 may a separately mounted display configured to be positioned on a user's head. In such an example, the head-mounted display may be separate from and in communication with the user device 404 that performs the main processing. Additionally, although FIG. 4 depicts a certain number and arrangement of components, this is for illustrative purposes and not intended to be limiting. Other examples can include more components, fewer components, different components, or a different arrangement of the components shown in FIG. 4.

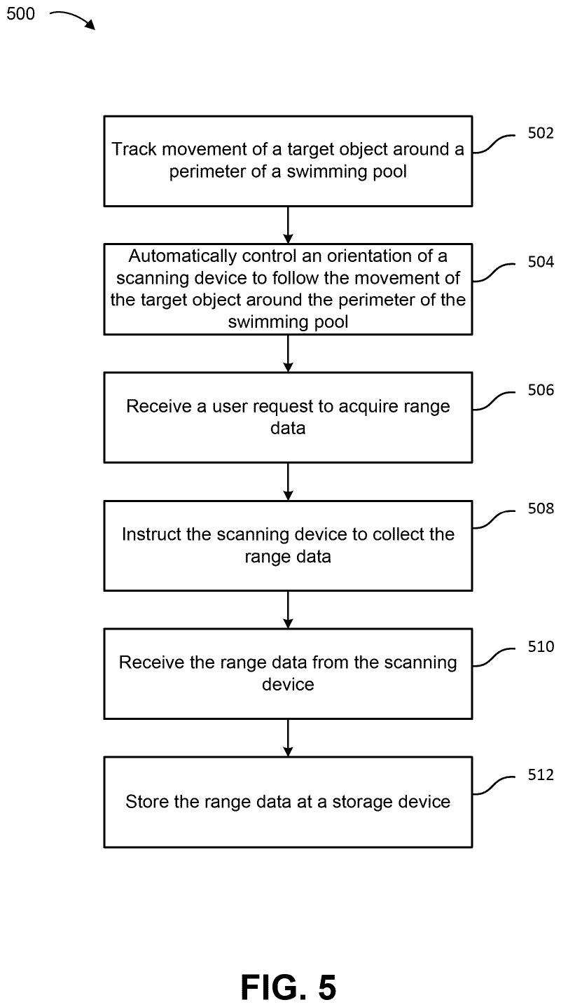

FIG. 5 is a flow chart of an example process 500 for locating a target positioned adjacent to a swimming pool and determining range data for the target, according to some aspects of the present disclosure. The process 500 can be performed by any of the computer systems described herein. Although FIG. 5 depicts the operations of process 500 having a certain sequence of steps, the particular operations are provided for illustrative purposes only. Other examples can involve more or fewer steps, different steps, or a different order of the steps shown in FIG. 5.

The process 500 can begin at block 502, where a processor (e.g., processor 420 and/or processor 440) can track movement of a target object as the target object moves around the perimeter of a swimming pool. An example of the target object can be the target 110 of FIG. 1. The processor can analyze images of the target object received from camera 422. The processor can use one or more image processing techniques like edge detection to determine the position of the target object within the images and determine a corresponding orientation of a ranging device 424 that points toward the target object.

At block 504, the processor can, while tracking the movement of the target object, automatically control the orientation of the ranging device 424 to follow the movement of the target object. In some examples, controlling the orientation of the ranging device 424 can include transmitting instructions to operate a drive assembly 426. For example, the drive assembly 426 can rotate the ranging device 424 about at least one axis orthogonal to a primary axis (e.g., along a field of capture) of the ranging device 424 to align the primary axis with the target object. Aligning the primary axis of the ranging device 424 can include the processor determining a current orientation of the ranging device 424, determining an aligned orientation based on analyzing the images of the target object, and using the drive to move the ranging device 424 according to the aligned orientation.

At block 506, the processor can receive a user request to acquire range data. The user request may be input into user device 404, for example by a user pressing a button on a touch screen of the user device 404. The user request can be received while the target object is positioned at a particular location around the perimeter of the swimming pool. For example, a user can position the target object at the location of a swimming pool cover anchor. Once positioned, the user can than press a button on the user device 404 to request range data corresponding to the target object at the location of the anchor.

At block 508, the processor can, in response to receiving the user request, instruct the ranging device 424 to generate the range data while the ranging device 424 is oriented toward the particular location. The range data can be collected using the ranging device 424. For example, the processor 440 can transmit an instruction to the ranging device 424 to have the ranging device 424 send out a light pulse at the target object to measure a spatial distance from the ranging device 424 and the target object. As another example, the ranging device 424 may be configured to collect range data at a predetermined cadence, so that the processor sends an instruction that includes a timestamp corresponding to the time of the received user request that is usable to obtain the collected range data corresponding to the timestamp. The collected range data (e.g., range data 416) may be transmitted from the ranging device 424 to the user device 404.

At block 510, the processor can receive the range data from the ranging device 424. At block 512, the processor can store the received range data (e.g., range data 434) at a storage device, for example storage 444.

In some examples, the above process may repeat any number of times. For instance, the target object may be repositioned at a second location around the perimeter of the swimming pool, which can be tracked by the processor. While at the second position, the processor can receive an additional user request to acquire additional range data. In response, the processor can instruct the ranging device 424 to collect the additional range data. The additional range data can be transmitted to the user device 404 and stored at a storage device 444. The processor can also use the range data and the additional range data to determine a segment distance between the first location and the second location or to derive other measurements associated with the perimeter of the swimming pool.

In some additional examples, the processor can receive a communication from the ranging device 424 indicating that the ranging device 424 has been successfully oriented toward the target object. For example, the ranging device 424 can determine that the ranging device is pointed toward the target object and the target object is stationary and suitable for collecting an accurate range measurement. In response to the communication, the processor can present a graphical representation to a user indicating that the scanning object is aligned with the target object. This can help the user know when to press the button to collect an accurate range measurement.

In some examples, the processor may transmit (e.g., via a network such as the Internet) the range data, or measurements derived from the range data, to a remote computing system that is located offsite from the swimming pool. The remote computing system may be associated with any suitable entity, such as a manufacturer of pool covers, liners, or other pool accessories. Based on the range data or measurements, the manufacturer may be able to construct a pool cover, liner, or other pool accessory that is customized to fit the swimming pool. For example, the manufacturer may use a computer aided design (CAD) tool (e.g., executing on the remote computing system) to develop a design of the pool accessory based on the range data and/or other measurements. The design can then be transmitted to one or more pieces of manufacturing equipment to initiate manufacturing of the pool accessory. After manufacturing, the accessory can be delivered to the pool site for installation.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A computer-implemented method, comprising:
tracking movement of a target object around a perimeter of a swimming pool by analyzing images of the target object received from a camera;
while tracking the movement of the target object around the perimeter of the swimming pool, automatically controlling an orientation of a ranging device to follow the movement of the target object around the perimeter of the swimming pool;
while the target object is positioned at a particular location around the perimeter of the swimming pool, receiving a user request to acquire range data, the range data indicating a spatial distance from the ranging device to the particular location;
in response to receiving the user request, instructing the ranging device to collect the range data while the ranging device is oriented toward the particular location;
receiving the range data from the ranging device; and
storing the range data to a storage device.

2. The method of claim 1, wherein the particular location is a first location, and further comprising:
while the target object is positioned at a second location around the perimeter of the swimming pool, receiving an additional user request to acquire additional range data, the additional range data indicating another spatial distance from the ranging device to the second location;
in response to receiving the additional user request, instructing the ranging device to collect the additional range data while the ranging device is oriented toward the second location;
receiving the additional range data from the ranging device; and
determining a segment distance between the first location and the second location based on the range data and the additional range data.

3. The method of claim 1, wherein orienting the ranging device comprises:
determining a current orientation of the ranging device;
analyzing the images using one or more image processing techniques to determine an offset between the current orientation and an aligned orientation; and
controlling, using the offset, the ranging device to rotate about at least one axis orthogonal to a primary axis of the ranging device to align the primary axis with the target object according to the aligned orientation.

4. The method of claim 1, wherein the ranging device is mounted in a fixed alignment with the camera, and automatically controlling the orientation of the ranging device comprises transmitting commands to an actuator for moving the camera to point at the target object based on the images.

5. The method of claim 1, further comprising generating a virtual model of the swimming pool based on the range data.

6. The method of claim 1, further comprising receiving an additional indication that the ranging device has been successfully oriented toward the target object.

7. The method of claim 1, wherein the ranging device comprises a laser range finder.

8. The method of claim 1, wherein the target object comprises a machine-readable optical label.

9. The method of claim 1, further comprising:
generating, by a user device, guidance for a user to position the target object at an additional location adjacent to the perimeter of the swimming pool; and
presenting, by the user device, the guidance in a graphical user interface to the user.

10. A system comprising:
a scanning subsystem comprising a camera and a ranging device;
one or more processors; and
one or more memories including instructions executable by the one or more processors for causing the one or more processors to perform operations including:
tracking movement of a target object around a perimeter of a swimming pool by analyzing images of the target object received from the camera;
while tracking the movement of the target object around the perimeter of the swimming pool, automatically controlling an orientation of the ranging device to follow the movement of the target object around the perimeter of the swimming pool;
while the target object is positioned at a particular location around the perimeter of the swimming pool, receiving a user request to acquire range data, the range data indicating a spatial distance from the ranging device to the particular location;
in response to receiving the user request, instructing the ranging device to collect the range data while the ranging device is oriented toward the particular location;
receiving the range data from the ranging device; and
storing the range data to a storage device.

11. The system of claim 10, wherein the particular location is a first location, and wherein the operations further comprise:
while the target object is positioned at a second location around the perimeter of the swimming pool, receiving an additional user request to acquire additional range data, the additional range data indicating another spatial distance from the ranging device to the second location;
in response to receiving the additional user request, instructing the ranging device to collect the additional range data while the ranging device is oriented toward the second location;
receiving the additional range data from the ranging device; and
determining a segment distance between the first location and the second location based on the range data and the additional range data.

12. The system of claim 10, wherein the operations further comprise:
determining a current orientation of the ranging device;
analyzing the images using one or more image processing techniques to determine an offset between the current orientation and an aligned orientation; and
controlling, using the offset, the ranging device to rotate about at least one axis orthogonal to a primary axis of the ranging device to align the primary axis with the target object according to the aligned orientation.

13. The system of claim 10, wherein the ranging device is mounted in a fixed alignment with the camera, and automatically controlling the orientation of the ranging device comprises transmitting commands to an actuator for moving the camera to point at the target object based on the images.

14. The system of claim 10, wherein the operations further comprise generating a virtual model of the swimming pool based on the range data.

15. The system of claim 10, wherein the operations further comprise receiving an additional indication that the ranging device has been successfully oriented toward the target object.

16. The system of claim 10, wherein the ranging device comprises a laser range finder.

17. The system of claim 10, wherein the target object comprises a machine-readable optical label.

18. The system of claim 10, wherein the operations further comprise:
generating guidance for a user to position the target object at an additional location adjacent to the perimeter of the swimming pool; and
presenting the guidance in a graphical user interface to the user.

19. The system of claim 10, wherein the particular location corresponds to an anchor location.

20. A non-transitory computer-readable medium comprising program code that is executable by one or more processors for causing a system to perform operations including:
tracking movement of a target object around a perimeter of a swimming pool by analyzing images of the target object received from a camera;
while tracking the movement of the target object around the perimeter of the swimming pool, automatically controlling an orientation of a ranging device to follow the movement of the target object around the perimeter of the swimming pool;
while the target object is positioned at a particular location around the perimeter of the swimming pool, receiving a user request to acquire range data, the range data indicating a spatial distance from the ranging device to the particular location;
in response to receiving the user request, instructing the ranging device to collect the range data while the ranging device is oriented toward the particular location;
receiving the range data from the ranging device; and
storing the range data to a storage device.
